(19) United States
(12) Patent Application Publication
(10) Pub. No.: US 2004/0253496 A1
(43) Pub. Date: Dec. 16, 2004

(54) Planar substrate-based fuel cell membrane electrode assembly and integrated circuitry

(76) Inventor: Ronald B. Foster, Fayetteville, AR (US)

Correspondence Address: HEAD, JOHNSON & KACHIGIAN, 228 W 17TH PLACE, TULSA, OK, 74119, US

(21) Appl. No.: 10/884,144

(22) Filed: Jun. 30, 2004

Related U.S. Application Data
(63) Continuation-in-part of application No. 09/821,505, filed on Mar. 30, 2001.

(51) Int. Cl. H01M 8/10; H01M 4/86; H01M 4/94; H01M 8/04; H01M 4/92

(52) U.S. Cl. 429/30; 429/44; 429/22

(57) ABSTRACT

Disclosed is a Proton exchange Membrane (PEM) fuel cell Membrane Electrode Assembly (MEA) apparatus constructed on a planar substrate. The substrate provides mechanical support for the MEA and also facilitates the inclusion of further integrated circuitry operably coupled to the MEA. Also disclosed is integrated circuitry providing MEA fuel cells with self-contained control circuitry, as well as integrated circuitry with self-contained fuel cell power sources. The invention also provides increased MEA performance and reduced cost as a result of the reduced thickness of the electrolyte material.

### CROSS REFERENCE TO RELATED APPLICATIONS

This application is a continuation-in-part application claiming priority to U.S. patent application Ser. No. 09/821,505, filed Mar. 30, 2001, and entitled “Planar Substrate-Based Fuel Cell Membrane Electrode Assembly and Integrated Circuitry”.

### TECHNICAL FIELD

This invention relates to proton exchange membrane (PEM) fuel cells and, in particular, to planar substrate based membrane electrode assemblies (MEAs) for PEM fuel cells. Additionally, the invention relates to the integration of MEAs and additional circuitry on a common substrate.

### BACKGROUND OF THE INVENTION

Generally, fuel cells for the production of electrical energy from a fuel and oxidant are known in the art. In a fuel cell, electric power and water vapor (as a by-product) are produced when fluid hydrogen and oxygen, usually in the form of gases, provided to anode and cathode electrodes respectively, react through an electrolyte. Electric power produced is then collected by the lead lines for delivery to a remote driven device such as a circuit or an electric motor.

Essentially, the reaction is an oxidation of the fuel, but the method results in direct production of electrical energy, with heat energy being produced as a side effect. As an alternative to hydrogen gas, other fuels containing hydrogen may be used. Methanol is one such fuel, particularly advantageous due to a high specific energy density. A specific problem exists with the use of methanol fuel in a PEM fuel cell. Unreacted methanol may diffuse across the membrane to the cathode and react. This has the effect of reducing overall energy efficiency and potentially can result in accumulation of methanol at the cathode. Special care must be taken to design a PEM fuel cell to be compatible with methanol. In addition, Direct Methanol Fuel Cells (DMFCs) typically have a lower output voltage under load. This means that more individual cells are required to be connected in series in order to achieve a particular system output voltage.

In operation, hydrogen gas or other fuel is provided in the anode side of the fuel cell body, oxygen gas as oxidant is provided in the cathode side. The hydrogen and oxygen then react, producing a useful electric current, and water vapor as a by-product. The electrolyte can be a solid, a molten paste, a free-flowing liquid, or a liquid trapped in a matrix. The solid type of electrolyte, or Proton exchange Membrane (PEM), is well known in the art.

A key component of a Proton exchange Membrane (PEM) fuel cell is the Membrane Electrode Assembly (MEA). The MEA performs the essential electrochemical functions of the fuel cell. It incorporates gas diffusion electrodes, catalysts, anode and cathode conductors, and a film of electrolyte acting as a proton conductor. In a conventional PEM fuel cell MEA, the film of electrolyte provides mechanical support for the MEA. Thin electrolyte membranes, however, are desirable for performance reasons.

Attempts to make thin membranes are limited by the requirement for mechanical strength, and thinner membranes result in loss of flexibility in applications. In addition, today's state-of-the-art PEMs are designed for operation at elevated temperatures where the water may evaporate from the membrane. The membrane requires some water content in order to maintain high proton conductivity. As a normal part of fuel cell functioning, water is produced at the cathode. Some of this water may back-diffuse through the membrane and provide hydration at the anode surface. However, for thick membranes operated at high temperature, this back-diffusion may be insufficient to keep the anode hydrated. This generally leads to the requirement for external humidification of the gas stream, and associated added system complexity.

An additional problem in applying thin-film materials is parasitic series resistance that must be minimized in order to maintain adequate electrical efficiency. U.S. Pat. No. 6,638,654 to Jankowski et al. describes a method for forming a fuel cell combining MEMS technology and thin-film deposition technology. The design taught by Jankowski et al. has a substantial limitation; it requires the fuel to diffuse through a nickel film, and water to diffuse away from the interface. A second substantial limitation of this approach is the high resistance of the thin-film anode and cathode conductors to current flow, resulting in a substantial reduction of electrical efficiency. There is a need for a fuel cell device that minimizes resistance to electrical current.

In making electrical and fluidic connections to a fuel cell, it is desirable to make electrical connections to a single side of the substrate. In a useful fuel cell power supply, multiple cells are stacked together in order to add voltage. The anode of one cell must be electrically connected to the cathode of the adjacent cell. Existing connection approaches are somewhat awkward and further constrain the methods used in packaging a fuel cell power supply. It is advantageous to have both anode and cathode connections available on a single surface of the membrane electrode assembly.

### SUMMARY OF THE INVENTION

Disclosed is a proton exchange membrane (PEM) fuel cell Membrane Electrode Assembly (MEA) apparatus constructed on a conductive planar substrate having a porous region. The substrate provides mechanical support for the MEA catalyst and electrolyte materials, and electrodes, as well as providing for electronic conduction.

Also disclosed is a proton exchange membrane (PEM) fuel cell membrane electrode assembly (MEA) apparatus constructed on a planar substrate having an integrated circuit operably coupled to the MEA, wherein the integrated circuit portion includes at least one transistor. More generally the integrated circuit portion may include transistors, diodes, resistors, capacitors and inductors interconnected to perform a given function.

The invention disclosed herein also includes embodiments wherein the integrated circuit portion includes a fuel cell control circuit and/or additional circuitry powered by the output of the MEA.

Technical advantages realized by the invention include increased performance and reduced cost as a result of the reduced thickness of the MEA electrolyte of the invention and of the reduced parasitic electrical resistance provided by passing the current through the conductive substrate as opposed to a thin-film layer.

Additional advantages are provided by the invention, including the ability to integrate the MEA with additional circuitry on a common substrate. This results in further advantages including giving broad flexibility to construct an integrated circuit with an MEA based power source, and to construct fuel cells which include additional circuitry. Further advantages will be apparent to those skilled in the arts.

### BRIEF DESCRIPTION OF THE DRAWINGS

The features of the present invention will be more clearly understood from consideration of the following description in connection with the accompanying drawings in which:

FIG. 1 is a device fabrication process flow diagram;

FIGS. 2A-2F are device cross-section views corresponding to the process flow of FIG. 1;

FIG. 2G is a plan view corresponding to FIG. 2F;

FIGS. 2H-2L are device cross-section views corresponding to the process flow of FIG. 1;

FIG. 2M is a plan view corresponding to FIG. 2L;

FIG. 2N is a device cross-section view corresponding to the process flow of FIG. 1;

FIG. 20 is a plan view corresponding to FIG. 2N;

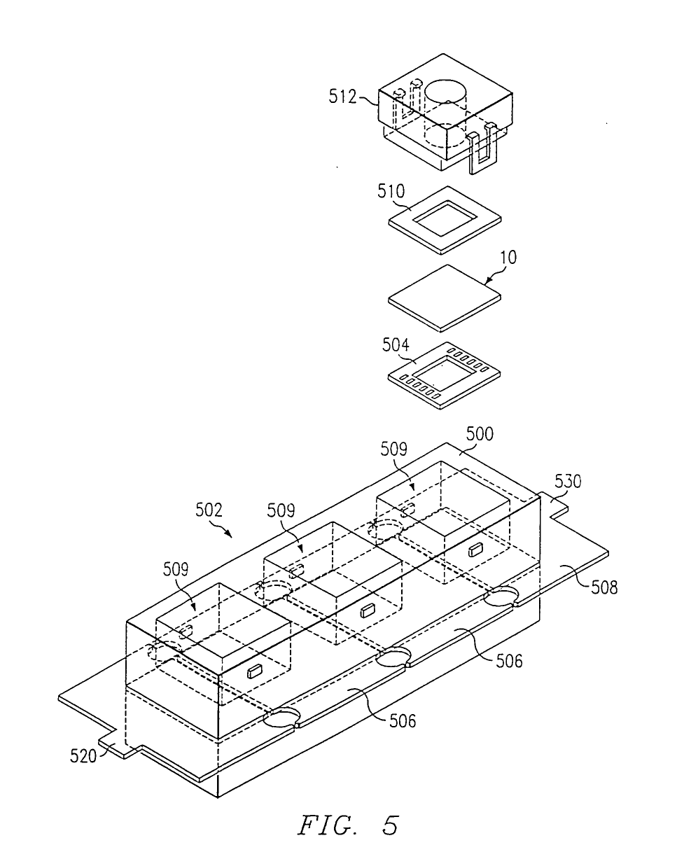

FIG. 3 shows another example of a device cross-section;

FIG. 4 shows another example of a device cross-section; and

FIG. 5 is a top front perspective view of an MEA, fuel cell body, and fuel cell stack, according to one embodiment of the invention.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not limit the scope of the invention. When referring to the drawings, like reference numbers are used for like parts throughout the various views. Directional references such as, front, back, side, top, bottom, used in the discussion of the drawings are intended for convenient reference to the drawings themselves as laid out on the page, and are not intended to limit the orientation of the invention unless specifically indicated. The drawings are not to scale and some features have been exaggerated in order to show particular aspects of the invention. It should be understood that the definition of anode and cathode are somewhat arbitrary depending on to which side of the fuel cell the fuel is applied and to which side the oxidant is applied. Therefore, terms anode and cathode and may be used interchangeability.

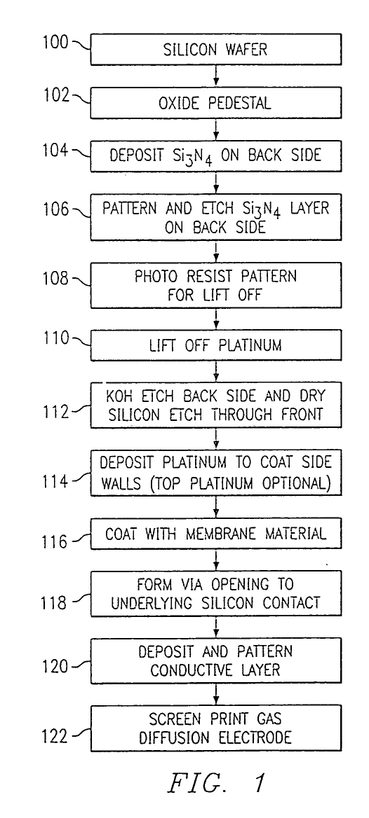

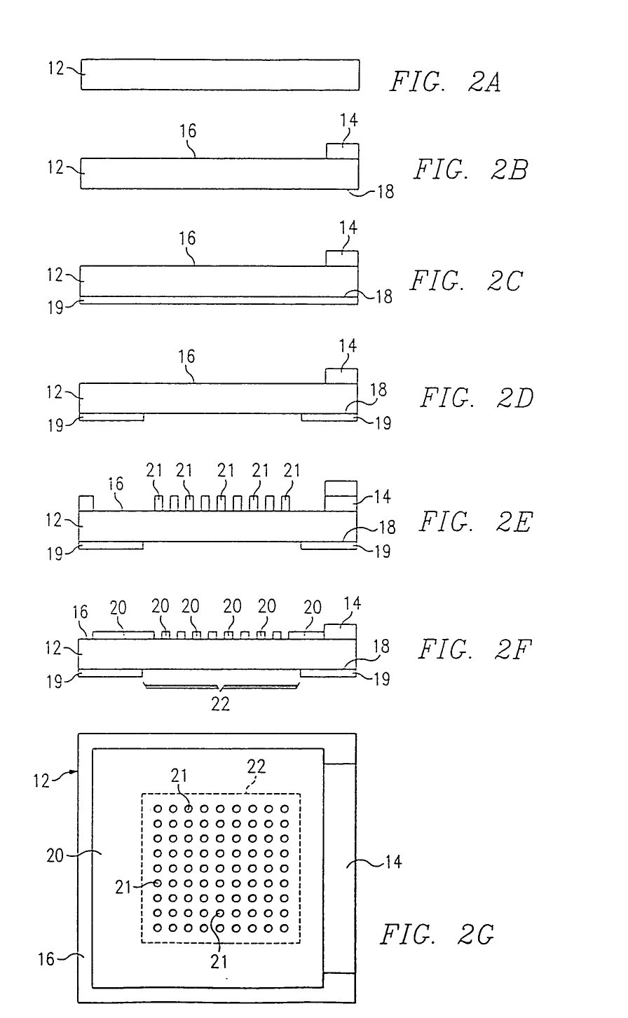

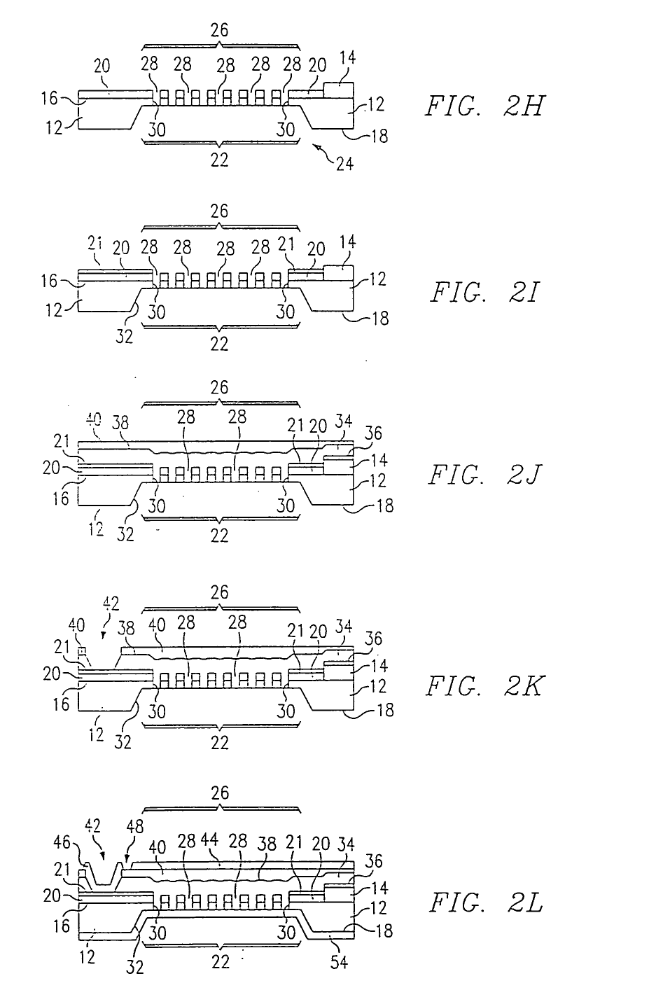

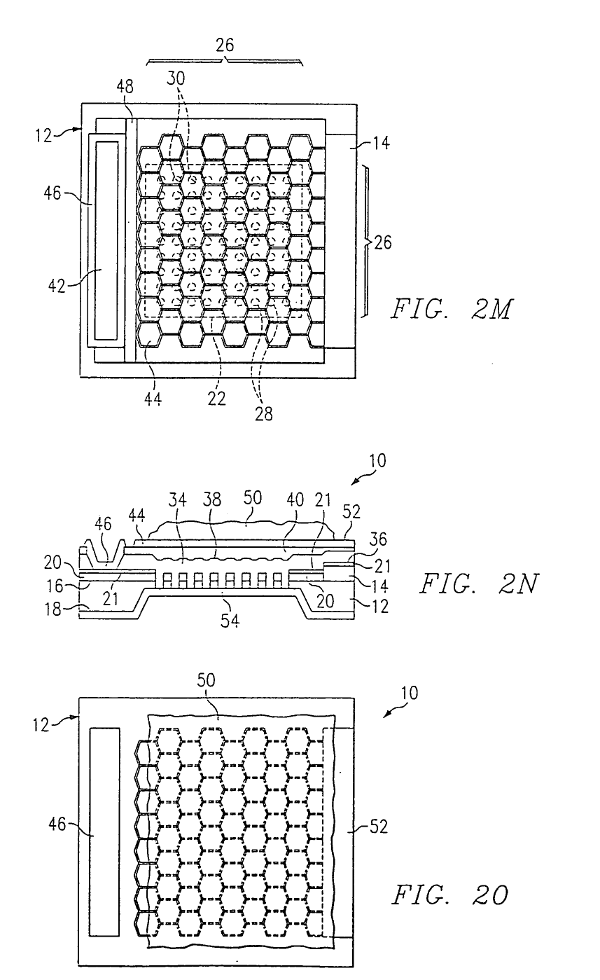

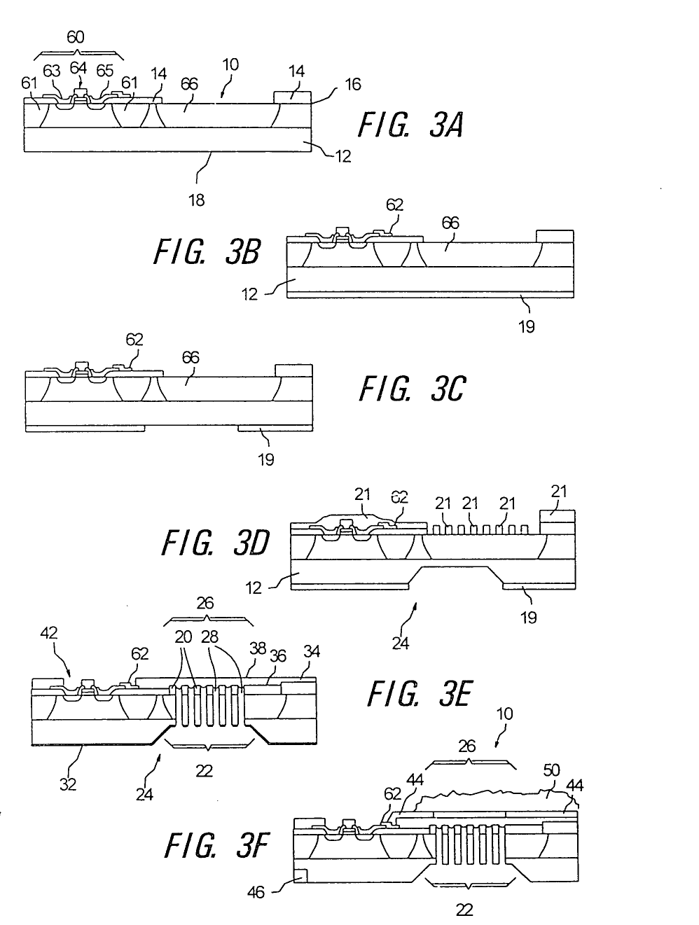

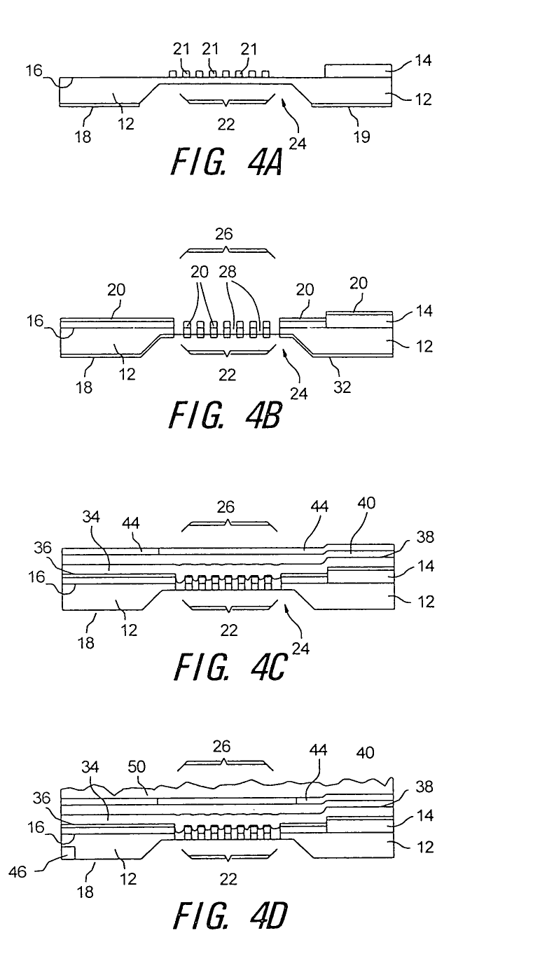

To better understand the invention, reference is made to FIGS. 1 and 2. In this example of a preferred embodiment of the invention, a silicon substrate, or wafer, is used. It should be understood by those skilled in the arts that other materials may be used such as, for example, a sapphire wafer having a conductive silicon layer, or material known as III-V semiconductor. In FIGS. 2N and 2O, an MEA 10 is shown constructed on a silicon substrate 12.

Preferably, in order to enable anisotropic etching of the silicon, a substrate 12 with [100] faceplane orientation is used 100. In order to provide for good electrical conductivity, the silicon substrate 12 is preferably heavily doped with Boron, a P-type dopant although other dopants may be used. While the dopant type may be either N-type or P-type, a superior ohmic contact between platinum and silicon can be obtained by applying a heavily-doped P-type wafer.

Typically, a silicon dioxide layer is grown on the substrate 12, patterned and etched in order to form 102 an insulating pedestal 14 on the front side 16 of the substrate 12. This initial pattern must be well aligned to the crystal plane, which is referenced to the flat on the substrate 12. Except for the insulating pedestal 14, both the front 16 and back 18 surfaces of the silicon substrate 12 are preferably left bare initially. In the preferred embodiment, an oxide thickness greater than or equal to about 1.0 microns is used, although thicknesses in the range of approximately 0.05-5.0 microns may also be used. The insulating pedestal 14 prevents mechanica7l abrasion of the MEA 10 from forming an undesired electrical contact between the anode conductor 44 and the underlying substrate 12.

A silicon nitride (Si₃N₄) film of thickness range 0.02-2.0 microns is now applied to the polished back surface 18 of the silicon wafer 12 by Low Pressure Chemical Vapor Deposition (LPCVD), Plasma Enhanced Chemical Vapor Deposition (PECVD) or sputtering method 104. The backside 18 of the silicon wafer 12 is then coated with photoresist, aligned, exposed and developed. The alignment must include provision to also align the backside pattern to the frontside pattern. The silicon nitride layer is etched by plasma method 106. If silicon nitride was also deposited onto the front surface 16 of the wafer 12 (such as with LPCVD) it is now removed. Photoresist is then stripped from the wafer 12, leaving a patterned Si.sub.3N.sub.4 layer 19.

A hard mask material 20 is applied to the front surface 16 of the substrate 12, preferably using suitable patterned photoresist techniques 108. Platinum is preferred as a hard mask 20, since it may also function as a catalyst, although other metals or combinations of metals such as iridium, palladium, gold, rhodium, molybdenum, and nickel may be also used. Preferably, once the front surface 16 is prepared with a patterned photoresist, then a platinum layer 20 of thickness in a range of 1-200 nanometers is deposited onto the front surface 16. In the preferred embodiment, the thickness is about 5 nanometers. A “lift-off” is performed 110, resulting in retention of the frontside platinum layer 20 in the field, but removal of platinum in the patterned areas, where photoresist was present prior to lift-off. It should be understood that the photoresist layer may be used to cover regions such as the oxide pedestal 14 where it is desirable to prevent deposition of hard mask 20, as well as to leave pillars 21 of photoresist distributed across the active area 22 of the MEA 10. Preferably, these circular pillars 21 of photoresist may be about 0.3 microns in diameter, roughly 0.2-2.0 microns tall, and have center-to-center spacing of about 0.6 microns. However, it should be understood that the photoresist pillars 21 could be of another size, optionally as small as approximately 50 nanometers diameter, and optionally spaced as closely as about 100 nanometers center-to-center. Alternative shapes for photoresist pillars such as variously proportioned rectangles, hexagons, or other polygons may be used.

A diaphragm area 24 is etched 112 into the back surface 18 of the substrate 12 using anisotropic etching techniques, preferably leaving a diaphragm 24 in the range of 5-100 microns in thickness. Various mixtures and various etch bath temperatures may be used without altering the character of the invention so long as the etch proceeds anisotopically, exposing the [111] planes of the silicon crystal, and results in a well-controlled etched diaphragm 24 such as is known in the art. During the backside 18 anisotropic silicon etch, the front side 16 is protected. A number of protection techniques are available, including wax mounting to a substrate, mounting in a TEFLON (a registered trademark of I. E. DuPont Nemours and Company) fixture with 0-rings for sealing, or application of temporary protection layers such as chromium. It should be noted that when a suitable pattern is provided on the back surface 18 of the substrate 12, it is placed in alignment with the pattern chosen for the front surface 16. Preferably, the backside silicon nitride layer 19 is removed by conventional methods once the diaphragm area 24 has been completed.

A porous region 26 of the substrate 12 is provided, preferably by exposing the front surface 16 of the substrate 12 to a dry plasma silicon etch 112. Holes 28 are etched through the remaining thickness of the substrate 12 so that the porous region 26 generally corresponds to the active area 22. Known techniques may be used for dry anisotropic plasma etch of the substrate 12. According to the limitations of these techniques, a hole 28 with an aspect ratio of roughly 70-80 may be created without loss of vertical dimensional control. That is, for a hole 28 of diameter 0.3 microns, a hole depth of (0.3*80=24 microns) can be created with nearly perfect vertical sidewalls 30. For holes deeper than this, erosion of the deepest portion of the hole can result, and the hole effectively widens. The present invention is tolerant of such hole erosion, since the primary requirement is simply for mechanical stability of the porous region 26 of the substrate 12. Therefore, flexibility exists to make the hole 28 diameters as small as about 50 nanometers, with center-to-center spacing as small as approximately 100 nanometers. During the anisotropic plasma etch of the substrate 12, the hard mask layer 20 prevents attack of the silicon in areas that are covered with hard mask 20. Additionally, the etch rate of silicon dioxide with plasma silicon etch technique is typically very small, such that if the insulating pedestal 14 is exposed to the plasma etch, it is reduced in thickness only slightly.

A back surface 18 catalyst layer 32, preferably platinum as discussed above with reference to front surface hard mask 20, is typically applied by sputtering or evaporation techniques 114, and preferably both the top and/or bottom platinum layers 20, 32, may be reacted to convert partially or fully to a silicide. This allows for excellent ohmic contact of the hard mask layer 20, and catalyst layer 32, to the underlying substrate 12, in all areas not protected by an insulating layer. Siliciding temperatures of 275.degree. C. or less for short time periods may result in partial consumption of the platinum layers 20, 32, in order to form platinum silicide. If desired to fully convert the platinum 20, 32 to a silicide layer, then higher temperatures and longer time periods may be used. It is preferred that the back surface catalyst layer 32 partially coats the sidewalls 30 of the etched holes 28.

Optionally, an additional front surface deposition of catalyst 21, in this case platinum, may also be applied in order to further coat the sidewalls 30 of the etched holes 28. Other catalyst metals or combinations of metals including ruthenium, rhodium, molybdenum, iridium, palladium, gold and nickel may be used. An alloy of platinum and ruthenium is well known in the art as an improved catalyst for direct methanol oxidation. Of course, a resist layer could be patterned and a second lift-off performed in order to prevent the catalyst 23 from being deposited over other portions of the substrate 12. As a further option, the additional front surface deposition may contain 1-50 nm of palladium in order to minimize cross-over of unreacted fuel, such as methanol, from anode to cathode. In this case, the complete deposition may include a layered stack of catalyst and palladium. Palladium is well known in the art as a material being permeable to hydrogen, although impermeable to a material such as methanol. In this case, sufficient thickness of palladium may be applied in order to fill in the porous regions of the substrate, resulting in a significant reduction in total methanol penetration.

A layer of proton-conducting electrolyte material, preferably NAFION, a registered trademark of I. E. DuPont Nemours and Company, is applied 116 to the front surface catalyst 23, preferably by spin or spray coating in order to form a membrane 34. Other perfluorocarbon materials may also be used and plasma enhanced deposition of the membrane material may also be used. It should be understood that all substrate 12 processing is preferably completed in a clean room, and that particulate contamination of the membrane 34 is minimized. In this manner, the integrity of the membrane 34 is maintained. Depending on final membrane 34 thickness desired, multiple coating steps 116 may be completed in succession in order to build up the membrane 34. It is preferable that the membrane material 34 at least partially penetrate the etched wafer holes 28. The minimum practical membrane 34 thickness is limited by the requirement to prevent electronically conductive short-circuit paths through the membrane 34, as well as to minimize cross-over of unreacted fuel. To the extent that the membrane material 34 penetrates the etched holes 28, the diffusion path for unreacted fuel through the membrane 34 is increased. However, it should also be understood that a thin membrane 34 is desirable, since a thin membrane provides less resistance to the drift of protons through the membrane 34. The resistance of the membrane can be better understood by reference to the governing equation:

R=t/(σ*A)

where R is the overall resistance of the membrane to proton flow in Ohms;

σ is the proton conductivity in Ohm⁻-cm⁻;

t is the thickness of the membrane in cm;

and A is the area in square cm of the membrane that is exposed to a flux of protons. Clearly, a thinner film will present less resistance to proton flow. The present embodiment of the invention is relatively insensitive to penetration of membrane material 34 into etched holes 28, since the nominal membrane 34 thickness is small, preferably within the range of approximately 0.1-30 microns. The proton-conducting membrane 34 has a cathode surface 36, and an anode surface 38, further discussed below.

In the preferred embodiment of the invention, a transition layer 40 is applied to the anode surface 38 of the membrane 34. The preferred transition layer 40 contains both perfluorocarbon material such as NAFION (a registered trademark of I. E. DuPont Nemours and Company) or similar material, and catalyst-coated carbon particles.

Optionally, it may be desirable to treat the total membrane 34, including transition layer 40, chemically in order to convert it to the protonic form, for example, by boiling the substrate 12 with attached membrane 34 in sulfuric acid followed by rinsing in de-ionized water to complete the required ion exchange.

A via 42 through the transition layer 40 and membrane 34, preferably created 118 by plasma etching, is provided in order to complete electrical contact to the underlying substrate 12. Either direct patterned photoresist or a sacrificial hard mask material may be used as protection during plasma etch.

Conductors, anode conductor 44, and cathode conductor 46, are preferably formed 120 by depositing a layered stack of conductive material, preferably topped with highly conductive metal such as, for example, gold or platinum. Lift-off technique may optionally be used for pattern definition. A gap 48 defining conductors 44, 46, formed by the etching of a single conductive stack is shown. An adhesion layer such as chrome or copper or titanium-tungsten (TiW) alloy may optionally be applied as a first portion of the conductive stack material. The conductive stack material may be patterned in an array in order to enhance the distribution of electric current. A hexagonal array is preferred as a pattern which results in low lateral electrical resistance and proffers little resistance to gas flow. Of course, another connecting pattern may be used.

A thick film gas diffusion electrode (GDE) layer 50 is added 122 at the top of the MEA 10. The thick film GDE layer 50 includes catalyst-coated carbon particles. Preferably, the GDE layer 50 is applied by screen-printing or spraying through a stencil mask. The GDE layer 50 overlaps the active area 22 of the MEA 10, and additionally overlaps the anode current collector region 52 of the anode conductor 44 in order to ensure good electrical contact between the GDE 50, anode conductor 44, and anode current collector region 52.

A water barrier 54 is preferably applied to the back side catalyst 32, preferably by spin-coating or spray-coating. The water barrier 54 preferably includes TEFLON, (a registered trademark of I. E. DuPont Nemours and Company,) or other hydrophobic material to prevent liquid water from forming on the cathode surface 36 during operation, in turn preventing oxygen from coming in contact with the catalyst layer 32 and interfering with the desired reaction. In the case that front side is cathode and back side is anode, water barrier 54 may alternatively be applied to the front side.

In the present invention, lateral electrical resistance increases monotonically as the size of the unit cell increases. For some applications, this may be of concern. Therefore, the thickness of the conductive layers may be adjusted as appropriate in order to reduce this lateral resistance. For instance, the platinum layer 32 which coats the substrate 12 at the back side 18 may be arbitrarily increased in thickness. Additionally, the catalyst 32 may be made up of strata by applying an underlayer of more abundant conductive metal overlain with a layer of more ideal conductor, such as platinum. The anode conductor layer 44 may be increased in thickness in order to decrease the sheet resistance.

It will be apparent to those skilled in the arts that an MEA 10 according to the invention may be completed on a wafer substrate 12 and then separated using known dicing techniques, such that multiple individual unit MEAs 10 may be produced. It will also be apparent that the possible MEAs 10, according to the invention, are bounded in size only by available wafer size at the large end, and available dicing techniques at the small end, and are advantageously suited for assembly into fuel cells in a corresponding range of sizes.

FIG. 3 illustrates another example of the invention including the MEA 10 also shown and described with reference to FIGS. 1 and 2. An Integrated Circuit (IC) 60 incorporating at least one electronic transistor is shown sharing the substrate 12 with MBA 10. IC 60 includes but is not limited to electrical isolation means 61, supply voltage electrical contact 65, ground voltage electrical contact 63 and functional transistor 64. The IC 60 is preferably coupled to the MEA 10 by coplanar power connection 62 to the anode conductor 44. In the preferred embodiment, the conductive substrate 12 is a common connection to circuit ground for both the integrated circuit 60 and cathode current collector 46 of the MEA 10. Optionally, electrical isolation means 61 will be accomplished by a diffused junction method during IC 60 preparation. In this case, diffused junction 66 may be prepared simultaneously with isolation means 61. Alternatively a separate coplanar power connection (not shown) may be made between circuit ground and cathode current collector 46. The IC 60 may be any circuitry for which a self-contained power source is desired. Optionally, the IC 60 may also include a fuel cell control circuit. The preferred fuel cell control circuit provides sensing and control functions adapted for monitoring and regulating fuel cell operation.

In FIG. 3, a substrate 12 with [100] faceplane orientation is used 100. A silicon dioxide layer is grown on the substrate 12, patterned and etched in order to form an insulating pedestal 14 on the front side of the substrate 12. Otherwise, both the front 16 and back 18 surfaces of the silicon substrate 12 are initially left bare.

A silicon nitride layer 19 is now applied to the back surface 18 of the silicon wafer 12. The backside 18 of the silicon wafer 12 is then coated with photoresist, aligned, exposed and developed. Silicon nitride layer 19 is removed by etch method from regions not protected by photoresist. If silicon nitride was also deposited onto the front surface 16 of the wafer 12, it is also removed. Photoresist is then stripped from the wafer 12, leaving a patterned silicon nitride layer 19. A photoresist layer 21 is applied to the front surface, preferably using suitable patterned photoresist techniques 108. Hard mask material 20 is applied to the front surface 16 of the substrate 12 by liftoff technique. Preferably, a platinum layer 20 is deposited onto the front surface 16.

A diaphragm area 24 is etched 112 into the back surface 18 of the substrate 12 using anisotropic etching techniques. During the backside 18 anisotropic silicon etch, the front side 16 is protected. Preferably, the backside silicon nitride layer 19 is removed once the diaphragm area 24 has been completed. A porous region 26 of the substrate 12 is provided. Holes 28 are etched through the remaining thickness of the substrate 12 so that the porous region 26 generally corresponds to the active area 22. During the anisotropic plasma etch of the substrate 12, the hard mask layer 20 prevents attack of the silicon in areas that are covered by the hard mask 20. A back surface 18 catalyst layer 32 is applied, and may be reacted at this point to convert partially or fully to a silicide.

A layer of proton conducting electrolyte material 34 is applied 116 to the front side 16. The proton-conducting electrolyte material 34 has a cathode surface 36, and an anode surface 38. Via 42 is opened through proton conducting electrolyte material 34 to allow for electrical connection to coplanar power connector 62. Conductive metal is deposited to front side 16, patterned and etched to form anode conductor 44. Preferably, anode conductor 44 is patterned in a manner that minimizes overlap of conductive metal over etched holes 28. A gas diffusion electrode (GDE) layer 50 is added 122 to the top of the MBA 10. Layer 50 makes electrical connection to anode conductor 44, which in turn makes electrical connection to coplanar power connector 62.

Persons skilled in the arts will recognize that the IC 60 may be constructed on the substrate 12 according to known methods prior to fabrication of the MEA 10 so long as care is taken to protect the IC 60 from damage during assembly of the MEA 10. Preferably, the insulating pedestal 14 is fashioned as a part of the fabrication sequence for the IC 60. It is also preferred that processing temperatures (in steps 100-122) be held below roughly 500° C. in order to prevent uncontrolled changes in the properties of the IC 60. For example, LPCVD silicon nitride (typically requiring temperatures of about 750° C.), should not be used for backside protection, but rather, sputter or PECVD deposition. In addition, when dry silicon etch procedures are used, the IC 60 portion of the substrate 12 is preferably protected from the etch by the addition of a thick photoresist layer deposited and patterned according to known methods.

It should be understood that variations in the layout of the MEA 10 and IC 60 shown and described are possible without departure from the concept of the invention. For example, referring to FIG. 4, simplification of the MEA structure may be made if co-planar conductors 44, 46 are not required. Specifically, the via 42 (FIG. 2) and associated steps 118 may be omitted, and conductors 44 and 46 will be arranged at the front 16 and back 18 side of the wafer 12, respectively. Alternate construction is illustrated in FIG. 4. A substrate 12 with [100] faceplane orientation is used 100. A silicon dioxide layer is grown on the substrate 12, patterned and etched in order to form 102 an insulating pedestal 14 on the front side of the substrate 12. Otherwise, both the front 16 and back 18 surfaces of the silicon substrate 12 are initially left bare.

A silicon nitride layer 19 is now applied to the back surface 18 of the silicon wafer 12. The backside 18 of the silicon wafer 12 is the coated with photoresist, aligned, exposed and developed. Silicon nitride layer 19 is removed by etch method from regions not protected by photoresist. If silicon nitride was also deposited onto the front surface 16 of the wafer 12, it is also removed. Photoresist is then stripped from the wafer 12, leaving a patterned silicon nitride layer 19, which is subsequently removed once the diaphragm area 24 has been completed. A photoresist layer 21 is applied to the front surface, preferably using suitable patterned photoresist techniques 108. Hard mask material 20 is applied to the front surface 16 of the substrate 12 by liftoff technique. Preferably, a platinum layer 20 is deposited onto the front surface 16.

A diaphragm area 24 is etched 112 into the back surface 18 of the substrate 12 using anisotropic etching techniques. During the backside 18 anisotropic silicon etch, the front side 16 is protected. Preferably, the backside silicon nitride layer 19 is removed once the diaphragm area 24 has been completed. A porous region 26 of the substrate 12 is provided. Holes 28 are etched through the remaining thickness of the substrate 12 so that the porous region 26 generally corresponds to the active area 22. During the anisotropic plasma etch of the substrate 12, the hard mask layer 20 prevents attack of the silicon in areas that are covered by the hard mask 20. A back surface 18 catalyst layer 32 is applied, and may be reacted at this point to convert partially or fully to a silicide.

A layer of proton conducting electrolyte material 34 is applied 116 to the front surface catalyst 23. The proton conducting electrolyte material 34 has a cathode surface 36, and an anode surface 38. In the preferred embodiment, a transition layer 40 is applied to the anode surface 38 of membrane 34. Conductive metal is deposited to front side 16, patterned and etched to form anode conductor 44. Preferably, anode conductor 44 is patterned in a manner that minimizes overlap of conductive metal over etched holes 28. A gas diffusion electrode (GDE) layer 50 is added 122 to the top of the MEA 10. In this alternative construction, layer 50 functions as anode conductor 44, whereas substrate 12 functions as cathode conductor 46.

As will be obvious to those skilled in the art, it is highly important to minimize the series electrical resistance of the entire membrane electrode assembly, including both anode and cathode conductors. Thin-film deposition technology is limiting in the achievable series resistance. For example, the resistance of a thin-film conductor is:

R=(p/t)*(L/W)

where R is the overall resistance of the conductor to electron flow in Ohms;

p is the electron conductivity in Ohm-cm;

t is the thickness of the membrane in cm;

L is the length of the conductor in cm;

and W is the width of the conductor in cm.

For a high quality thin-film, ρ is about 5×10Exp(−6). Assuming that the aspect ratio (L/W) of the conductor is 2 for lateral current flow through the film and the film thickness is 5×10Exp(−7) cm, then the resistance R is 20 ohms. For a well-designed fuel cell it is desirable to have total series resistance of less than 1.0 ohms.

According to the present invention the electrical cathode current flows through the substrate, resulting in a considerably lower series resistance. For example, a typical planar conductive substrate fabricated from silicon may have resistivity of 2×10Exp(−2) ohm-cm and thickness of 5×10Exp(−2) cm. However, the aspect ratio (L/W) of the conductor is substantially less since the current is directed down instead of sideways through a thin film. Assuming an aspect ratio of 0.1 for vertical current flow through the substrate, the calculated resistance is:

R=(p/t)*(L/W)=(0.02/0.05)*0.1=0.04 Ohms

Similarly, the resistance of the anode conductor must be considered. Again, a high quality thin-film will have resistance of about 12 ohms. According to the present invention, a thick-film GDE layer 50 is deposited onto anode conductor 44 and is in intimate electrical contact with anode conductor 44. The GDE layer 50 is typically composed of catalyst-coated carbon particles having resistivity of about 1×10Exp(−2) Ohm-cm.

For a GDE layer of thickness 5×10Exp(−3) cm and aspect ratio 0.1, again assuming vertical current flow through the GDE layer, the resistance will be substantially lower than that of the thin-film anode conductor 44 alone:

R=(p/t)*(L/W)=(0.01/0.005)*0.1=0.2 Ohms

The combination of directing cathode current vertically through the conductive planar substrate and anode current vertically through a thick-film screen-printed or sprayed layer has a dramatic effect in lowering the parasitic series resistance relative to a thin-film device relying on lateral current flow.

In FIG. 5, a view of the invention is shown including a body 500 about the MEA 10. It should be understood that a variety of packaging methods may be used to incorporate the MEA 10 of the invention into a PEM fuel cell assembly 502. For example, the invention is compatible with, but not limited to fuel cell and fuel cell stack apparatus as disclosed in the U. S. Pat. No. 6,500,577 to Foster entitled “Modular Polymer Electrolyte Membrane Unit Fuel Cell Assembly and Fuel Cell Stack,” filed Dec. 19, 2000, which is hereby incorporated into the present application for all purposes by this reference.

A conductive seal 504 is used to provide hermetic sealing as well as providing an electrical path from the MEA 10 to external conductors 506, 508. A hermetic seal 510 is also provided, in addition to a lid 512. It should be clear that additional unit fuel cells 509, including additional elements 504, 10, 510, 512, are used to complete assembly 502, and that the results will be to add the voltages developed by each MEA 10. The terminal voltages for the completed assembly 502 will appear between end connectors 520 and 530.

It should be understood that many variations in the exact configuration and application of the invention are possible without departing from the inventive concepts. For example: The exact shape and configuration of the MEA and IC and their relative positions on the substrate are not critical to the invention and may be varied by those skilled in the arts; The anode and cathode may be interchanged by supplying fuel and oxygen to the sides of the MEA opposite from those shown; The assembly process used to produce the substrate-based MEA apparatus and/or IC may be varied. There is no limitation, according to the principals of the invention, to the number, size, complexity, content, or function of the integrated circuits coupled with one or more MEA on a common substrate, or to the number of individual invention apparatus which may be connected together.

The embodiments shown and described above are only exemplary. Many details are often found in the art such as variations in materials and connection of parts. Therefor many such details are neither shown nor described. It is not claimed that all of the details, parts, elements, or steps described and shown were invented herein. Even though numerous characteristics and advantages of the present inventions have been set forth in the foregoing description, together with details of the structure and function of the inventions, the disclosure is illustrative only, and changes may be made in the detail, especially in matters of arrangement of the functional parts within the principles of the inventions to the full extent indicated by the broad general meaning of the terms used in the attached claims.

I claim:

1. A Proton exchange Membrane (PEM) fuel cell Membrane Electrode Assembly (MEA) apparatus comprising:
a conductive planar substrate having a front surface and an opposing back surface, the conductive planar substrate also having a porous region;
catalyst material affixed to at least said back surface of said porous region;
proton exchange material affixed to said front surface of said conductive planar substrate, the proton exchange material having an anode surface and an opposing cathode surface;
an anode conductor coupled with said anode surface of said proton exchange material;
a thick film gas diffusion electrode affixed to said anode conductor; and
a cathode conductor coplanar with said anode conductor and electrically coupled to the conductive substrate through an opening in the proton exchange material.

2. An MEA according to claim 1 further comprising a layered stack of catalyst and palladium disposed between said front surface of said porous region of said planar substrate and said proton exchange material.

3. An MEA according to claim 1 further comprising a transition layer disposed between said proton exchange material and said anode conductor for improving catalysis of fuel.

4. An MEA according to claim 1 further comprising a water barrier adjacent to said back surface catalyst material.

5. An MEA according to claim 1 wherein said proton exchange material is less than approximately 30 microns thick.

7. An MEA according to claim 1 wherein said proton exchange material is less than approximately 5 microns thick.

8. An MEA according to claim 1 wherein said proton exchange material is less than approximately 1 micron thick.

9. An MEA according to claim 1 wherein said proton exchange material comprises a perfluorocarbon copolymer proton-conducting material.

10. An MEA according to claim 1 wherein said proton exchange material comprises a perfluorosulfonic acid polymer.

11. An MEA according to claim 1 wherein said catalyst material comprises one or more metals chosen from the group consisting of platinum, iridium, palladium, ruthenium, rhodium, molybdenum, gold, and nickel.

12. An MEA according to claim 1 wherein said catalyst material comprises platinum.

13. An MEA according to claim 1 wherein said catalyst material comprises an alloy of platinum and ruthenium.

14. An MBA according to claim 1 wherein said substrate comprises silicon.

15. An MBA according to claim 1 wherein said substrate comprises a conductive silicon layer on sapphire.

16. An MEA according to claim 1 wherein said substrate comprises one or more semiconductor compound selected from the group known as the III-V family.

17. An MEA according to claim 1 further comprising a fuel cell body operably connected to said MEA portion.

18. An MEA according to claim 1 further comprising an electronic circuit portion of said substrate and operably coupled to said anode conductor and said cathode conductor.

19. An MEA according to claim 18 wherein said electronic circuit is integral with said membrane electrode assembly.

20. An integrated circuit based fuel cell apparatus comprising:
a Proton exchange Membrane (PEM) fuel cell Membrane Electrode Assembly (MEA); and
an integrated circuit operably coupled to said membrane electrode assembly.

21. An integrated circuit based fuel cell apparatus according to claim 20 wherein said integrated circuit comprises a fuel cell control circuit.

22. An integrated circuit based fuel cell apparatus according to claim 20 wherein said integrated circuit comprises a driven device.

23. An integrated circuit based fuel cell apparatus according to claim 20 further comprising a fuel cell body operably connected to said MEA.

24. An integrated circuit based fuel cell apparatus according to claim 20 further comprising a planar substrate.

25. An integrated circuit based fuel cell apparatus according to claim 24 wherein said MEA further comprises a porous region of said planar substrate.

26. An integrated circuit based fuel cell apparatus according to claim 24 wherein said planar substrate comprises silicon.

27. An integrated circuit based fuel cell apparatus according to claim 24 wherein said planar substrate comprises a conductive silicon layer on sapphire.

28. An integrated circuit based fuel cell apparatus according to claim 24 wherein said substrate comprises one or more semiconductor compound selected from the group known as the III-V family.

29. An integrated circuit based fuel cell apparatus according to claim 20 wherein said proton exchange material comprises a perfluorocarbon copolymer proton-conducting material.

30. An integrated circuit based fuel cell apparatus according to claim 20 wherein said proton exchange material comprises a perfluorosulfonic acid polymer.

31. An integrated circuit based fuel cell apparatus according to claim 20 wherein said proton exchange material is less than approximately 30 microns thick.

32. An integrated circuit based fuel cell apparatus according to claim 20 wherein said proton exchange material is less than approximately 5 microns thick.

33. An integrated circuit based fuel cell apparatus according to claim 20 wherein said proton exchange material is less than approximately 1 micron thick.

34. An integrated circuit based fuel cell apparatus according to claim 20 wherein said MEA further comprises a catalyst comprising one or more metals selected from the group platinum, iridium, palladium, ruthenium, rhodium, molybdenum, gold, and nickel.

35. An integrated circuit based fuel cell apparatus according to claim 20 wherein said MEA further comprises a catalyst further comprising platinum.

36. An integrated circuit based fuel cell apparatus according to claim 20 wherein said MEA further comprises a catalyst further comprising an alloy of platinum and ruthenium.

37. An integrated circuit comprising:
a substrate having a proton exchange membrane (PEM) fuel cell Membrane Electrode Assembly (MEA) portion further comprising:
a porous region of said planar substrate having a front surface and an opposing back surface;
catalyst material affixed to said back surface and sidewalls of said porous region;
proton exchange material affixed to said front surface of planar substrate, the proton exchange material having an anode surface and an opposing cathode surface;
an anode conductor coupled with said anode surface of said proton exchange material;
a gas-diffusion electrode affixed to said anode conductor; a cathode conductor electrically coupled with said conductive portion of substrate wherein said cathode conductor is coplanar in relation to said anode conductor; and
said substrate also having an integrated circuit portion operably coupled to said MEA portion.

38. An integrated circuit according to claim 37 wherein said integrated circuit portion comprises a fuel cell control circuit.

39. An integrated circuit according to claim 37 wherein said integrated circuit portion comprises a driven device.

40. An integrated circuit according to claim 37 further comprising a fuel cell body operably connected to said MEA portion.

41. An integrated circuit according to claim 37 wherein said planar substrate comprises silicon.

42. An integrated circuit according to claim 37 wherein said planar substrate comprises silicon and sapphire.

43. An integrated circuit according to claim 37 wherein said substrate comprises one or more semiconductor compound selected from the group known as the III-V family.

44. An integrated circuit according to claim 37 wherein said proton exchange material comprises a perfluorocarbon copolymer proton-conducting material.

45. An integrated circuit according to claim 37 wherein said proton exchange material comprises a perfluorosulfonic acid polymer.

46. An integrated circuit according to claim 37 wherein said proton exchange material is less than approximately 30 mils thick.

47. An integrated circuit according to claim 37 wherein said proton exchange material is less than approximately 5 mils thick.

48. An integrated circuit according to claim 37 wherein said proton exchange material is less than approximately 1 mil thick.

49. An integrated circuit according to claim 37 wherein said catalyst comprises one or more metals selected from the group platinum, iridium, palladium, gold, and nickel.

50. An integrated circuit according to claim 37 wherein said catalyst comprises platinum.

51. An integrated circuit according to claim 37 wherein said catalyst comprises an alloy of platinum and ruthenium.

52. An integrated circuit according to claim 37 further comprising a layered stack of catalyst and palladium disposed between said front surface of said porous region of said planar substrate and said proton exchange material.

53. An integrated circuit according to claim 37 further comprising a transition layer disposed between said proton exchange material and said anode conductor for lowering lateral electrical resistance.

54. An integrated circuit according to claim 37 further comprising a water barrier adjacent to said back surface catalyst material.
